(19) United States
(12) Patent Application Publication
(10) Pub. No.: US 2013/0044272 A1
(43) Pub. Date: Feb. 21, 2013

(54) LED Backlight Driving Method, LED Backlight Driving Circuit and Liquid Crystal Display Device

(71) Applicant: Xinming Gao, Shenzhen (CN)

(72) Inventor: Xinming Gao, Shenzhen (CN)

(21) Appl. No.: 13/263,905

(22) PCT Filed: Sep. 7, 2011
(86) PCT No.: PCT/CN2011/079439

§ 371 Date: Oct. 11, 2011

(30) Foreign Application Priority Data
Aug. 18, 2011 (CN) 201110237439.2

(51) Int. Cl. G02F 1/1335; H05B 37/02

(52) U.S. Cl. 349/61; 315/192

(57) ABSTRACT

The present invention discloses a LED backlight driving method, a LED backlight driving circuit and a liquid crystal display (LCD) device, wherein said LED backlight driving method comprises the following steps: detecting the voltage and the current of each LED string, calculating the power of each LED string, and determining the reference power; and regulating the output power of each LED string until the output power is equal to said reference power. Because the present invention uses the constant power control mode, the LED brightness decline caused by heat can be compensated on the one hand; on the other hand, by automatically regulating the voltage and the current of the light bar, the current at high voltage drop becomes low, and the current at low voltage drop becomes high. Thus, there is a reduction of the consumption of the constant-current control circuit caused by different voltage drops and a reduction of the temperature.

### TECHNICAL FIELD

The present invention relates to the field of liquid crystal displays (LCDs), particularly to a light-emitting diode (LED) backlight driving method, a LED backlight driving circuit and a LCD device.

### BACKGROUND

The LED is usually used by the current LCD as a backlight. The constant current driving mode shown in FIG. 1 is used by the existing LED driver, and the constant LED current of each string light is controlled by the constant-current control circuit.

The minimum voltage is detected by the minimum-voltage open-loop detecting module so that the input voltage of the LED is optimized. The method has the defect that when the voltage drops of the LEDs are reduced, the light intensity is reduced, and the backlight brightness is also reduced after the LED temperature rises. In addition, the detection of the minimum voltage results in the difference of voltage drops of the LEDs between every two LED string lights adding to the constant current control circuit, causing unnecessary consumption.

### SUMMARY

The aim of the present invention is to provide a LED backlight driving method, a LED backlight driving circuit and a LCD device thereof with stable brightness.

The purpose of the present invention is achieved by the following technical schemes.

A LED backlight driving method comprises the following steps:

A: Detecting the voltage and current of each LED string, calculating the power of each LED string, and determining the reference power; and

B: Regulating the output power of each LED string until the output power is equal to said reference power.

Preferably, the reference power of each LED string is calculated in accordance with the preset proportion factor of voltage attenuation in said step A. The mode can increase the flexibility of voltage detection.

Preferably, the reference power in said step A is the average power of the output power of all the LED strings. The average power is used as a reference, so that the regulated output power of each LED string in later period can best approximate the preset requirement of brightness.

Preferably, said step B comprises the following steps.

B11: Calculating the reference current of each LED string in accordance with said reference power and the output voltage of each LED string;

B12: Regulating the output current of the corresponding LED string until the output current equals said reference current; and

B13: Calculating the output power of each LED string, judging whether the output power of the LED string is equal to the reference power; if equal, the regulation is completed; if not, return to step B1. This is one embodiment of step B. The current of each LED string is repeatedly regulated until the output power is equal to the reference power by using the reference power as a reference, so that the final output voltages and currents of all LED strings can be consistent.

Preferably, said step B comprises the following steps.

B21: Calculating the reference voltage of each LED string in accordance with said reference power and the output current of each LED string;

B22: Regulating the output voltage of the corresponding LED string until the output voltage equals said reference voltage; and

B23: Calculating the output power of each LED string, judging whether the output power of the LED string is equal to said reference power; if equal, the regulation is completed; if not, return to step B1. This is another embodiment of step B. The voltage of each LED string is repeatedly regulated until the output power is equal to the reference power by using the reference power as a reference, so that the final output voltages and currents of all LED strings can be consistent.

Preferably, the method further comprises step C after said step B. Feeding back said reference power to the power supply module, using the power supply module to regulate the output power in accordance with the preset requirement of brightness, and then returning to step A. The method can ensure that the output power of the voltage module meets the preset requirement of brightness.

A LED backlight driving circuit comprises multiple LED strings which are in parallel connection, and a power supply module which is used for supplying power for the LED strings; and said LED backlight driving circuit further comprises a capacity measurement module which is used for detecting the voltage and the current of each LED string, and a power balance module which is used for determining the reference power in accordance with the voltage and the current of each LED string and regulating the output power of each LED string in accordance with the reference power until the output power is equal to said reference power.

Preferably, said capacity measurement module comprises a voltage-detection circuit of LED string for detecting the voltage of each LED string, a current-detection circuit for detecting the current of each LED string, and a voltage-detection proportion-setting circuit for regulating the proportion factor of voltage attenuation of the LED string voltage-detection circuit; and said power balance module comprises a power-calculation circuit which is used for calculating the power and determining the reference power in accordance with the voltage and the current of each LED string, and a control circuit which is used for regulating the output power of each LED string until the output power is equal to said reference power. This is one embodiment of the capacity measurement module and the power balance module.

Preferably, said LED backlight driving circuit also comprises a power feedback module which is used for feeding back said reference power to said power supply module so that the power supply module can regulate the output power in accordance with the preset requirement of brightness. By adding the feedback module, the power supply module can regulate the output power in time to meet the preset requirement of brightness.

A LCD device comprises the aforementioned LED backlight driving circuit.

Because the present invention uses the constant power driving mode, it detect the voltage drop of the light bar and the current of the light bar synchronously, set the voltage attenuation proportion, and feed back the product of the voltage and the current, i.e. voltage*current. If the voltage is low, the current is high; if the current is high, the voltage becomes high. Finally, the product is compromised. Thus, the LED srting light with low voltage closes up to the LED string with high voltage; vice versa, the LED string with high voltage closes up to the LED string with low voltage. Finally, the voltage drops of the LEDs are very close in value; so there is a reduction of voltage that is once caused by differential voltage drops of the LEDs and applied to the current balance. When temperature rises, the backlight brightness is reduced; the LED voltage is reduced; while the current is increased. Thus, the backlight brightness is improved; the brightness difference under two temperature conditions is compensated; and the problem of brightness decay caused by LED temperature rise is solved. Meanwhile, by automatically regulating the voltage and the current of the light bar, there is a decrease of the current of the LED string with high voltage drop of the LED, and there is an increase of the current of the LED string with low voltage drop of the LED. Thus, there is a reduction of the consumption of the constant-current control circuit caused by different voltage drops of the LEDs and a decrease of the temperature.

### BRIEF DESCRIPTION OF FIGURES

FIG. 1 is the block diagram of the LED backlight of the prior art;

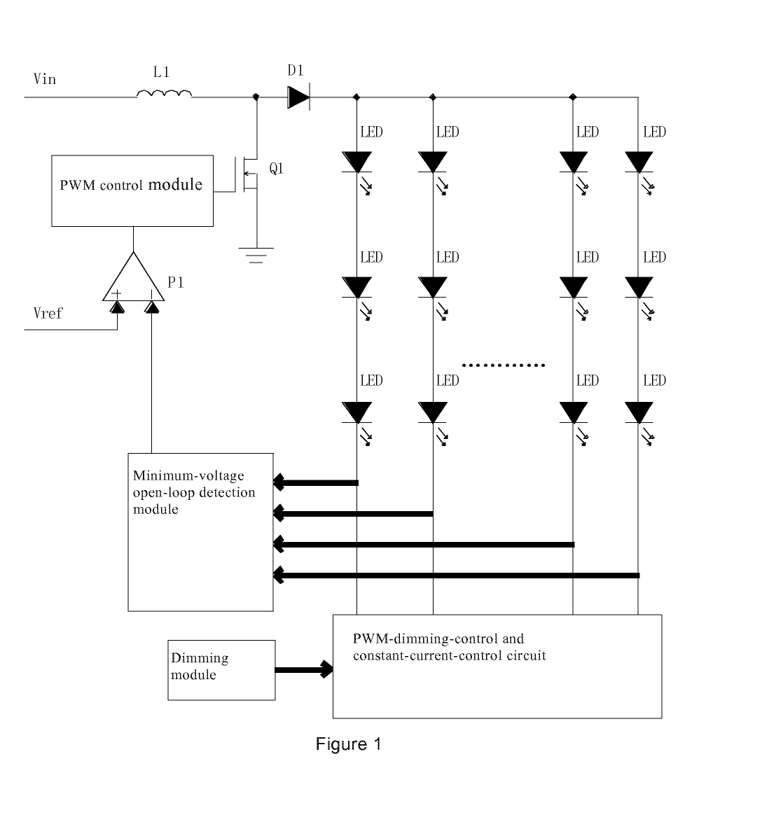

FIG. 2 is the flow diagram of a first embodiment of the LED backlight driving method of the present invention;

FIG. 3 is the flow diagram of a second embodiment of the LED backlight driving method of the present invention;

FIG. 4 is the block diagram of the LED backlight of the present invention;

FIG. 5 is the block diagram of one embodiment of the LED backlight driving method of the present invention.

Wherein: 1. power supply module; 2. LED string; 3, capacity measurement module; 31, voltage-detection proportion-setting circuit; 32. voltage-detection circuit of LED string; 33, current-detection circuit; 4, power balance module; 41, control circuit; 42, power-calculation circuit; 5, power feedback module; 6, PWM-dimming-control and power-balance module; 61, dimming module.

### DETAILED DESCRIPTION

The present invention will further be described in detail in accordance with the figures and the preferred embodiments.

The LED backlight driving method of the present invention has the principle to detect the voltage drop of the light bar and the current of the light bar synchronously, set the voltage attenuation proportion, and feed back the product of the voltage Vf and the current If of each LED string, i.e. Vf×If; if the Vf is low, the If is high; if the If is high, the Vf becomes high. Finally, the product is compromised. Thus, the LED string with low voltage Vf closes up to the LED string with high voltage Vf; vice versa, the LED string with high voltage Vf closes up to the LED string with low voltage Vf. Finally, the voltage drops of the LEDs are very close in value. Thus, there is a reduction of the voltage that is added to the current balance and is caused by different voltages (Vf) across the LEDs.

When temperature rises, the backlight brightness is reduced; and the LED Vf is reduced; while the If is increased. Thus, the backlight brightness can be improved, and the brightness difference under two temperature conditions can be compensated. The LED backlight driving method of the present invention will be further explained in accordance with the aforementioned principle and the embodiments.

The LED backlight driving method of one embodiment of the present invention comprises the following steps.

A: Detecting the voltage and the current of each LED string, calculating the power of each LED string, and determining the reference power; and

B: Regulating the output power of each LED string until the output power is equal to said reference power.

Preferably, the reference power in step A is the average power of the output power of each LED string, and the average power is used as a reference, so that the regulated output power of each LED string in later period can best approximate to the preset requirement of brightness.

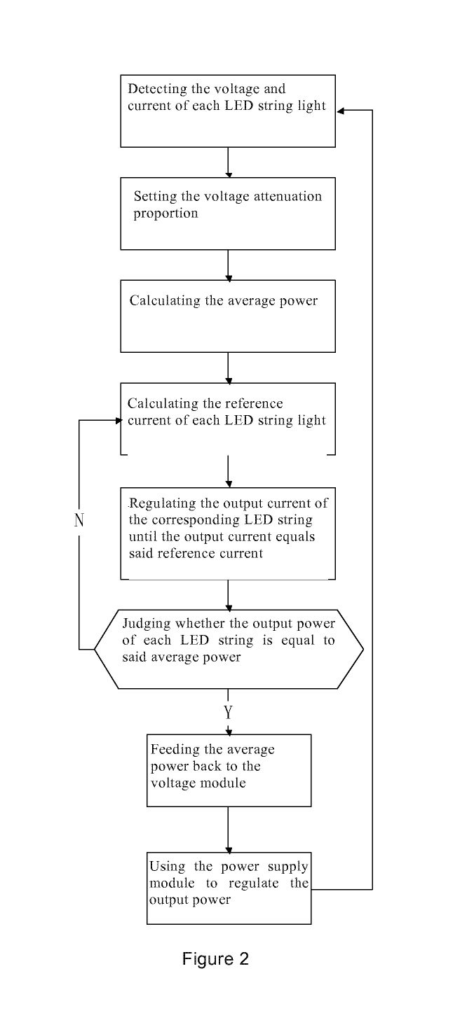

As shown in FIG. 2, in order to increase the flexibility of voltage detection, the reference power of each LED string 2 is calculated in accordance with the preset proportion factor of voltage attenuation in said step A.

To ensure that the output power of the voltage module can meet the preset requirement of brightness, the LED backlight driving method further comprises step C after step B: Feeding back said reference power to the power supply module 1, using the power supply module 1 to regulate the output power in accordance with the preset requirement of brightness, and then returning to step A.

To dynamically regulate the LED brightness, said LED backlight driving method also comprises step D: automatically regulating the LED brightness in accordance with the current display image, and then returning to step A.

In addition, said step B comprises the following steps:

B11: Calculating the reference current of each LED string 2 in accordance with said reference power and the output voltage of each LED string 2;

B12: Regulating the output current of the corresponding LED string 2 until the output current equals said reference current; and

B13: Calculating the output power of each LED string 2, judging whether the output power of the LED string 2 is equal to the reference power; if equal, the regulation is completed; if not, return to step B1.

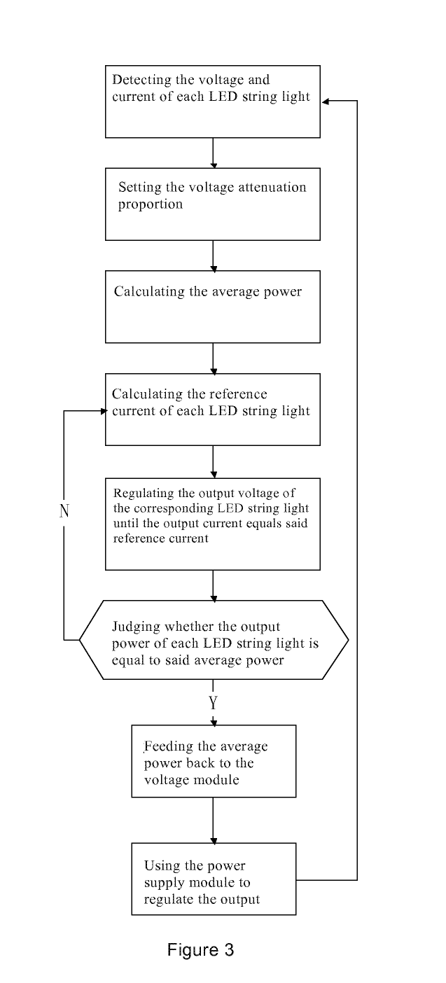

The flowchart of said LED backlight driving method of the other embodiment of the present invention is shown in FIG. 3. What is different from the aforementioned embodiment is that said step B comprises the following steps.

B21: Calculating the reference voltage of each LED string 2 in accordance with said reference power and the output current of each LED string 2;

B22: Regulating the output voltage of the corresponding LED string 2 until the output voltage equals said reference voltage; and

B23: Calculating the output power of each LED string 2, judging whether the output power of the LED string 2 is equal to the reference power; if equal, the regulation is completed; if not, return to step B1.

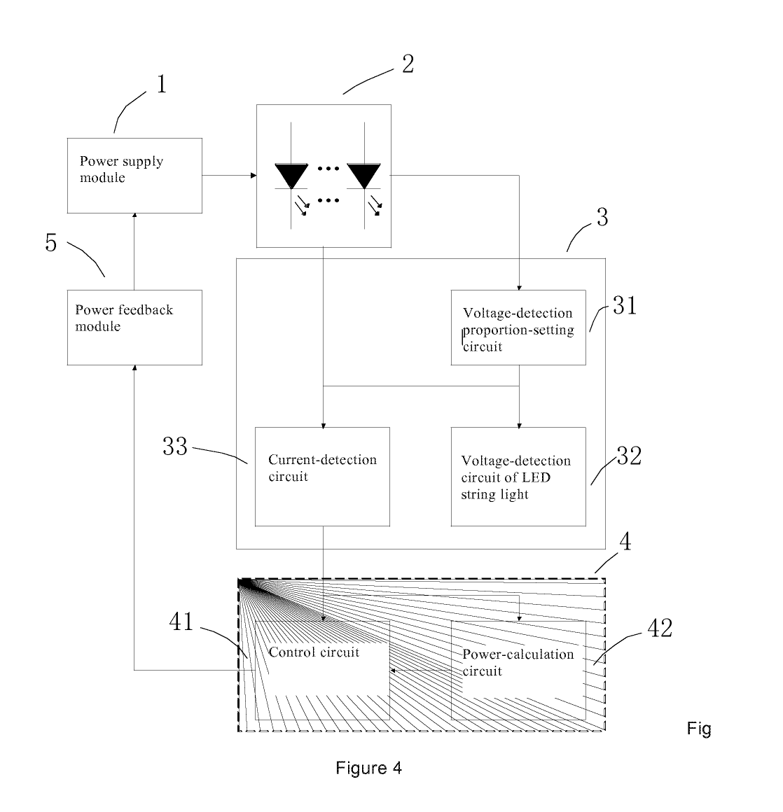

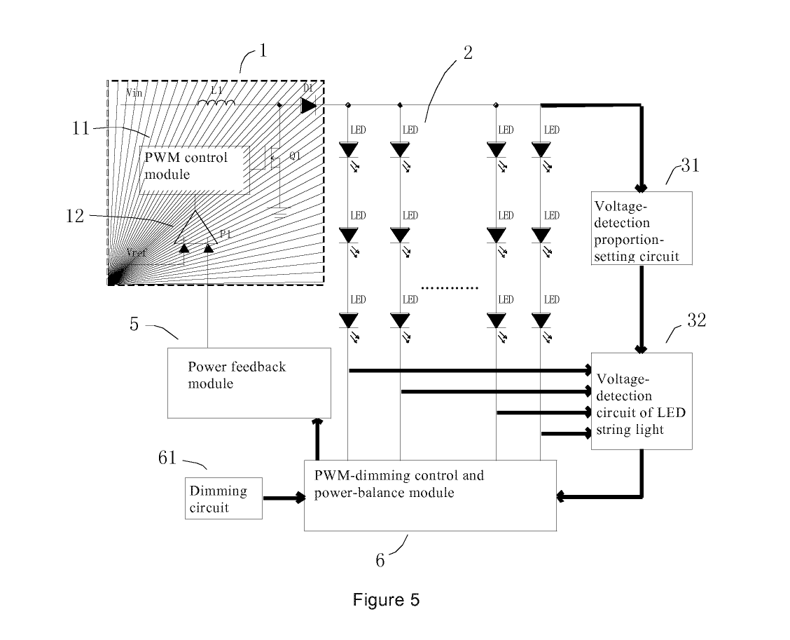

As shown in FIG. 4 and FIG. 5, the LED backlight driving circuit using the aforementioned LED backlight driving method comprises multiple LED strings 2 which are in parallel connection, and a power supply module 1 which is used for supplying power for the LED strings; and said LED backlight driving circuit further comprises a capacity measurement module 3 for measuring the voltage and current of each LED string 2, and a power balance module 4 which is used for determining the reference power in accordance with the voltage and current of each LED string 2 and regulating the output power of LED string 2 in accordance with the reference power until the output power is equal to said reference power.

Preferably, said capacity measurement module 3 comprises a voltage-detection circuit 32 of LED string for detecting the voltage of each LED string 2, a current-detection circuit 33 for detecting the current of each LED string 2, and a voltage-detection proportion-setting circuit 31 for regulating the proportion factor of voltage attenuation of the LED string voltage-detection circuit 32; said power balance module 4 comprises a power-calculation circuit 42 which is used for calculating the power and determining the reference power in accordance with the voltage and current of each LED string 2, and a control circuit 41 which is used for regulating the output power of each LED string 2 until the output power is equal to said reference power. This is one embodiment of the capacity measurement module 3 and the power balance module 4.

In order to make the output power of the power supply module 1 meet the preset requirement of brightness, said LED backlight driving circuit also comprises a power feedback module 5 which is used for feeding back said reference power to said power supply module 1 so that the power supply module 1 can regulate the output power in accordance with the preset requirement of brightness.

In order to dynamically regulate the LED brightness, said LED backlight driving circuit can also comprise a dimming control module 61 which is used for regulating the duty ratio of the output current of each LED string 2, wherein the dimming control module 61 comprises a dimming circuit for regulating LED brightness and a PWM-dimming-control circuit for regulating brightness to respond said dimming circuit. The PWM-dimming-control circuit controls the LED brightness by controlling the effective output current of each LED string 2.

Because said power balance module 4 has the function for regulating current. In the process of practical application, said power balance module 4 can be combined with the PWM-dimming-control circuit to form a PWM-dimming-control and power-balance module 4 to perform integral control. Thus, more flexible current control schemes can be provided.

A LCD device comprises the aforementioned LED backlight driving circuit.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A LED backlight driving method comprises the following steps:
A: detecting the voltage and the current of each LED string, calculating the power of each LED string, and determining the reference power; and
B: regulating the output power of each LED string until the output power is equal to said reference power.

2. LED backlight driving method of claim 1, wherein the reference power of each LED string is calculated in accordance with the preset proportion factor of voltage attenuation in said step A.

3. LED backlight driving method of claim 1, wherein the reference power in said step A is the average power of the output power of all the LED strings.

4. LED backlight driving method of claim 1, wherein said step B comprises the following steps:
B11: calculating the reference current of each LED string in accordance with said reference power and the output voltage of each LED string;
B12: regulating the output current of the corresponding LED string until the output current equals said reference current; and
B13: calculating the output power of each LED string, judging whether the output power of the LED string is equal to the reference power; if equal, the regulation is completed; if not, return to step B1.

5. LED backlight driving method of claim 1, wherein said step B comprises the following steps:
B21: calculating the reference voltage of each LED string in accordance with said reference power and the output current of each LED string;
B22: regulating the output voltage of the corresponding LED string until the output voltage equals said reference voltage; and
B23: calculating the output power of each LED string, judging whether the output power of the LED string is equal to said reference power; if equal, the regulation is completed; if not, return to step B1.

6. LED backlight driving method of claim 1, wherein the method further comprises step C after step B: feeding back said reference power to the power supply module, and using the power supply module to regulate the output power in accordance with the preset requirement of brightness, and then returning to step A.

7. A LED backlight driving circuit, comprising: multiple LED strings which are in parallel connection, a power supply module which is used for supplying power for the LED strings, a capacity measurement module which is used for detecting the voltage and the current of each LED string, and a power balance module which is used for determining the reference power in accordance with the voltage and the current of each LED string and regulating the output power of each LED string in accordance with the reference power until the output power is equal to said reference power.

8. LED backlight driving circuit of claim 7, wherein said capacity measurement module comprises a voltage-detection circuit of LED string for detecting the voltage of each LED string, a current-detection circuit for detecting the current of each LED string, and a voltage-detection proportion-setting circuit for regulating the proportion factor of voltage attenuation of the LED string voltage-detection circuit; and said power balance module comprises a power-calculation circuit which is used for calculating power and determining reference power in accordance with the voltage and the current of each LED string, and a control circuit which is used for regulating the output power of each LED string until the output power is equal to said reference power.

9. LED backlight driving circuit of claim 7, wherein said LED backlight driving circuit also comprises a power feedback module which is used for feeding back said reference power to said power supply module so that the power supply module can regulate the output power in accordance with the preset requirement of brightness.

10. A liquid crystal display (LCD) device, wherein said liquid crystal display device comprises the LED backlight driving circuit of claim 7; said LED backlight driving circuit comprises multiple LED strings which are in parallel connection, a power supply module which is used for supplying power for the LED strings, a capacity measurement module which is used for detecting the voltage and the current of each LED string, and a power balance module which is used for determining the reference power in accordance with the voltage and the current of each LED string and regulating the output power of each LED string in accordance with the reference power until the output power is equal to said reference power.

11. LCD device of claim 10, wherein said capacity measurement module comprises a LED string voltage-detection circuit for detecting the voltage of each LED string, a current-detection circuit for detecting the current of each LED string, and a voltage-detection proportion-setting circuit for regulating the proportion factor of voltage attenuation of the LED string voltage-detection circuit; and said power balance module comprises a power-calculation circuit which is used for calculating power and determining reference power in accordance with the voltage and the current of each LED string, and a control circuit which is used for regulating the output power of each LED string until the output power is equal to said reference power.

12. LCD device of claim 10, wherein said LED backlight driving circuit also comprises a power feedback module which is used for feeding back said reference power to said power supply module so that the power supply module can regulate the output power in accordance with the preset requirement of brightness.
